(19) United States
(12) Patent Application Publication
(10) Pub. No.: US 2013/0074664 A1
(43) Pub. Date: Mar. 28, 2013

(54) COMPLETE-CUT STATION AND METHOD FOR SEPARATING PACKAGES

(71) Applicant: Multivac Sepp Haggenmüller GmbH & Co. KG, Wolfertschwenden (DE)

(72) Inventor: Rimmel Ewald, Kleinwieler (DE)

(73) Assignee: Multivac Sepp Haggenmüller GmbH & Co. KG, Wolfertschwenden (DE)

(21) Appl. No.: 13/627,535

(22) Filed: Sep. 26, 2012

(30) Foreign Application Priority Data
Sep. 27, 2011 (DE) 102011115142.0

(51) Int. Cl. B26D 1/01

(52) U.S. Cl. CPC B26D 1/015
USPC 83/13; 83/202

(57) ABSTRACT

A complete-cut station for separating several packages from a coherent film. The complete-cut station may comprise several cutting tools, each cutting tool having cutting knives for separating one or more packages from the coherent film. At least one of the cutting tools may be adjustable with respect to its position relative to another cutting tool. In addition, a common lifting gear for all cutting tools may be provided to lift the coherent film to engage the cutting tools. The invention further relates to a corresponding method for separating packages from a coherent film using the complete-cut station of the present invention.

### CROSS-REFERENCE TO RELATED APPLICATIONS

This Application claims priority to German Application Number 102011115142.0 filed Sep. 27, 2011 to Ewald Rimmel entitled “Complete-Cut Station and Method for Separating Packages,” currently pending, the entire disclosure of which is incorporated herein by reference.

### FIELD OF THE INVENTION

The invention relates to a complete-cut station and to a method for separating several packages from a coherent film.

### BACKGROUND OF THE INVENTION

A complete-cut station and a method for separating packages that are produced in one common coherent film are currently used in packaging machines. Frequently, complete-cut stations are used in packaging machines in which packages are produced from or with a plastic sheet, e.g. in deep-drawing machines For reasons of efficiency, packages may be frequently produced using several tracks and several rows, i.e. an array of packages is produced in one work cycle, with several packages being provided one behind the other as well as side by side in the direction of production. These packages may be joined together in one common coherent film, as at least one film (i.e. the lower film and/or the upper film) that extends continuously across all packages, connecting these packages to one another. If deep-drawing machines are used, it is often the lower film in which package troughs are deep-drawn, and the upper film is sealed simultaneously onto a plurality of package troughs or trays.

On principle, there are two different possibilities to separate such packages joined by a coherent film. In the first alternative, a longitudinal cutting device and a cross-cutting device are provided one behind the other, i.e. separated from each other, in the direction of transport. First, the cross-cutting devices are usually set between adjacent rows of packages, i.e. the coherent film is cut through between adjacent rows. Subsequently, the longitudinal cutting device may then separate the packages of the respective tracks.

In the second alternative, on which the present invention is based, packages may be cut out or punched out of the coherent film in one work step.

### SUMMARY OF THE INVENTION

It is the object of the present invention to improve a complete-cut station and a method for separating packages using a complete-cut station to obtain higher-quality packaging.

This object is achieved by a complete-cut station comprising several cutting tools. Each cutting tool may, in turn, be provided with one or more cutting knives either for separating an individual package or for separating several packages. For example, the cutting knives of a cutting tool may be adapted to cut all packages out of the coherent film of a complete track or row of an array of packages, thereby separating them. At least one of these cutting tools may be adjustable with respect to its position relative to another cutting tool. This feature has the effect that the cutting contour produced by the complete-cut station as a whole is variable without exchanging or changing the cutting knives. This configuration has the enormous advantage that the cutting contour can be varied if a variation, e.g. with respect to the position of the sealed seams of the packages to be separated, is present. Such a variation can occur, for example, if a different packaging material is used or if the environmental conditions and, thus, the properties of the packaging material change. In particular, this may result in a different warpage of the packaging film as the coherent film is fed forward. This warpage can now be compensated in whole or in part by varying the position of the cutting tools in the complete-cut station. Thus, the cutting contour produced by the complete-cut station as a whole can be optimized with respect to the position and the course of the sealed seams of the packages. This increases the quality of the packages and may result in an excess width of a sealed seam, which had frequently been necessary in former times for reasons of safety, being reduced or even totally omitted, thereby saving material and, ultimately reducing the packaging costs.

Another great advantage of the invention may be achieved by providing one common lifting gear for all cutting tools despite the relative adjustability of positions. Thus, not only the drive of the cutting tools remains simple, but it also ensures, in a constructively simple manner, that all packages are cut out of the coherent film at the same time or approximately at the same time.

In particular, an adjustment of the cutting contour to a changing position of the sealed seams of the packages may be easily possible when the at least one adjustable cutting tool is adjustable with respect to its position in a horizontal direction relative to another cutting tool.

In general, an optimum adjustment of the cutting contour to the sealed seams of the packages can be achieved if the at least one adjustable cutting tool is adjustable with respect to its position in a direction parallel to a direction of production of the complete-cut station and/or transversely to this direction of production. In particular, an optimum adjustment of the cutting contour to the sealed seams may be obtained if no sealed seams are affected by the cutting contour of the complete-cut station, so that all sealed seams are preserved in terms of their original width and strength.

It would be conceivable that more than one cutting tool is adjustable relative to one another with respect to their positions. For example, a separate cutting tool could be provided for each row or each track of packages in an array of packages of more than two rows or three rows (or two or three tracks, respectively). Also, several separate cutting tools could be provided per row or track of packages. In an extreme case even a separate cutting tool would be provided for each single package, which is adjustable with respect to its position relative to the other cutting tools or a stationary cutting tool. The finer the subdivision of the complete-cut station into several separate cutting tools, i.e. the more cutting tools adjustable relative to one another are provided, the more effective the cutting contour may be varied and optimized with respect to the position of the sealed seams.

One embodiment includes a stop or an oblong hole guide to limit the adjustability of at least one of the adjustable cutting tools. This defines and limits the adjustment travel distance of the cutting tool and can thus facilitate the adjustment of a desired cutting contour.

In another embodiment, a conveyor belt or other conveying means for separated packages is provided underneath the cutting tools. As a result of gravity, or otherwise assisted by another appropriate guidance mechanism, the packages cut out of the coherent film by means of the complete-cut station may be transferred to the conveying means or onto outer packaging conveyed on the conveyor belt or other conveying means. The conveyor belt or other conveying means can then remove the separated packages from the complete-cut station.

According to another embodiment of the invention, a measuring device for detecting the position of sealed seams on packages is provided. This measuring device can comprise, for example, a sensor for detecting the position of the sealed seam. The detected position can be transmitted to and processed by a controller, and can be used for an optimum alignment of the cutting tools. The advantage thereof is that this may be accomplished automatically, without the interference by the user, even during the operation.

The invention further relates to the embodiments of a packaging machine comprising a complete-cut station of the above-described type, and to a method for separating packages from a coherent film using the complete-cut station of the present invention. The method provides for the production of sealed seams on several packages joined together in a coherent film, e.g. in a sealing station of a packaging machine.

Furthermore, the packaging machine or the complete-cut station may make a correlation between the position of the sealed seams and the position of the cuts in the coherent film producible or already produced by one or more cutting tools of a complete-cut station. Different possibilities are feasible for this method step. In one alternative embodiment, sealed seams are produced and the packages are then separated by the cutting tools of the complete-cut station. Subsequently, an automatic or manual or visual inspection of the correlation between the produced cuts and the position of the sealed seams takes place. It could be checked, for example, whether the cutting contour of the complete-cut station has contacted the sealed seams or cut through the sealed seams somewhere. Depending on the correlation checked in this way the position of one or more cutting tools of the complete-cut station can now be varied relative to the position of another cutting tool so as to optimize the position of the cutting contour with respect to the position of the sealed seams. In another alternative embodiment, the position of the sealed seams is detected before the packages are separated in the complete-cut station. Depending on this detected position of the sealed seams, the position of one or more cutting tools of the complete-cut station can be varied still before the packages are separated. In this case, too, the position of the cutting contour may be optimized with respect to the position of the sealed seams. Each cutting tool may be associated with a tray receptacle for receiving one or more trays.

In the method according to the invention it may be provided that a lifting motion of all tray receptacles of the complete-cut station is driven by a common lifting gear for all tray receptacles so as to move by this lifting motion all packages to the cutting tools, which, if necessary, are driven in the opposite sense, thereby separating them from the coherent film. Despite the possibility to adjust the position of the cutting tools, this step renders the method particularly simple.

According to an embodiment of the present method, the position of a sealed seam on one or more packages may be detected, and the adjustment of the position of one or more cutting tools is carried out in dependence on the detected position of the sealed seam. As was already described above, the sealed seam can be detected visually by an operator, or automatically by means of measuring device suited for this purpose. This measuring device could be, for example, a camera having a suited image evaluation software capable of detecting the position of the sealed seams from the recorded image of an array of packages.

In addition, or alternatively, correlating the position of the sealed seams with the position of the cuts producible by one or more cutting tools of the complete-cut station could also be realized by measuring a feed length of the coherent film, e.g. by a vision system detecting the position of sealed seams and/or markings on the packaging film. Changes in the feed length could then correspondingly be converted into changes of the relative positional relationship between the cutting tools of the complete-cut station so as to align the cutting tools, and specifically their cutting knives, optimally with respect to the position of the sealed seams.

Also, it was already explained that a particularly favorable adjustment of the cutting contour is ensured if the adjustment of the adjustable cutting tool(s) is accomplished in a horizontal direction.

The quality of the cuts made to separate the packages from the coherent film can additionally be improved through another embodiment of the present invention wherein the coherent film is clamped in a clamping frame prior to the separation of the packages. In particular, the clamping frame could clamp horizontal flanges or edges of the packages on which usually also the sealed seams of the packages are provided.

Other and further objects of the invention, together with the features of novelty appurtenant thereto, will appear in the course of the following description.

### DESCRIPTION OF THE SEVERAL VIEWS OF THE DRAWING

In the accompanying drawings, which form a part of the specification and are to be read in conjunction therewith, in which like reference numerals are used to indicate like or similar parts in the various views:

FIG. 1 is a side view of a deep-drawing packaging machine including a complete-cut station in accordance with one embodiment of the present invention;

FIG. 2 is a top view of an array of packages having three tracks and four rows to be separated by a complete-cut station in accordance with one embodiment of the present invention;

FIG. 3 is a side view of a complete-cut station according to one embodiment of the present invention;

FIG. 4 is a top view of a complete-cut station having two cutting tools according to one embodiment of the present invention;

FIG. 5 is a side view of view of a complete-cut station according to another embodiment of the present invention;

FIG. 6 is a side view of view of a complete-cut station according to one embodiment of the present invention during the separation of packages; and

FIG. 7 is a side view of view of a complete-cut station according to one embodiment of the present invention after the separation of packages.

Like components are provided with like reference numbers throughout the figures.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

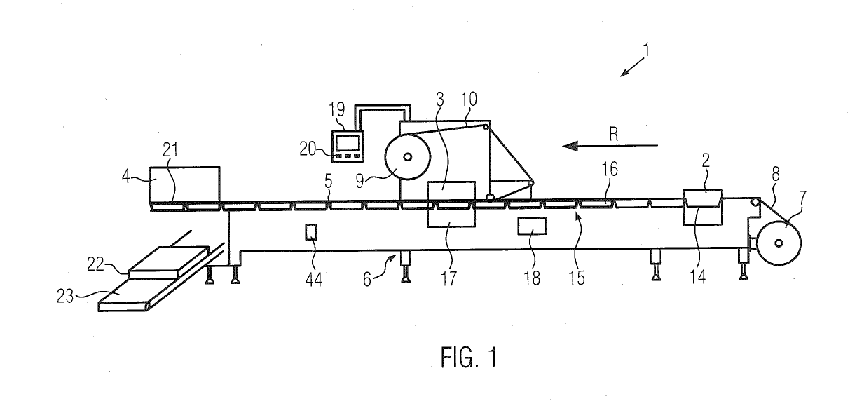

FIG. 1 shows a schematic view of a packaging machine 1 according to the invention in the form of a deep-drawing machine. This deep-drawing machine 1 comprises a forming station 2, a sealing station 3 and a complete-cut station 4 according to the invention, which are arranged in this order in a working direction R on a machine frame 6. On the input side a feed roller 7 is mounted on the machine frame 6, from which a film 8 is withdrawn. In the region of the sealing station 3 a material storage 9 is provided from which a cover film 10 is withdrawn. The packaging machine 1 further comprises a non-illustrated feed device, which grips the film 8 and conveys it further in the working direction R per main work cycle. The feed device can be, for example, conveyor chains arranged on both sides of the film 8

In the represented embodiment the forming station 2 is realized as a deep-drawing station, in which troughs 14 are formed into the film 8 by deep-drawing. The forming station 2 may be configured such that several troughs are formed side by side in the direction perpendicular to the working direction R. A charging section 15 is provided in the working direction R behind the forming station 2, in which troughs 14 formed in the film 8 are manually or automatically filled with a product 16.

The sealing station 3 has a closable chamber 17 in which the atmosphere in the package troughs 14 can be replaced prior to the sealing, e.g. by gas-flushing with a replacement gas or a gas mixture. Alternatively, the package troughs 14 may be evacuated in the closable chamber 17.

In the complete-cut station 4 the packages produced together in one work cycle of the packaging machine 1 are separated at the same time, i.e. they are cut out of the coherent film 5 simultaneously. This coherent film 5 is made of the lower film 8 and the cover film 10, through which all packages of the group of packages are joined together. In the complete-cut station each package is cut out or punched out of the coherent film 5 in one single operation.

The packaging machine 1 further comprises a controller 18. The controller 18 has the task of controlling and monitoring the processes executed in the packaging machine 1. A display device 19 with operating elements 20 serves to visualize and influence the process operations in the packaging machine 1 for or by an operator, respectively.

The general operating mode of the packaging machine 1 will be briefly described below.

The lower film 8 is withdrawn from the feed roller 7 and conveyed by a feed device into the forming station 2. In the forming station 2 troughs 14 are formed in the film 8 by means of deep-drawing. The troughs 14 and the surrounding region of the film 8 are conveyed in one main work cycle further to the charging section 15, in which they are filled with a product 16.

Subsequently, in another main work cycle, the filled troughs 14 and the region of the film 8 surrounding them are conveyed further by the feed device into the sealing station 3. After the covering film 10 has been sealed to the film 8 it is conveyed further by a feed motion of the film 8, whereby the cover film 10 is withdrawn from the material storage 9. By sealing the covering film 10 onto the package troughs 14 sealed packages 21 are created, which are initially still joined together in one common coherent film 5. As explained, this coherent film is formed of the lower film 8 and the cover film 10. In the complete-cut station 4 the packages 21 are eventually separated.

Outer packagings 22, e.g. cartons, may be provided in the region of the complete-cut station 4 to receive separated packages 21. FIG. 1 shows an alternative in which outer packagings 22 are conveyed by means of a conveying member, e.g. a conveyor belt 23, to a position underneath the complete-cut station 4. There, each outer packaging 22 can be filled from above by means of one or more groups of simultaneously produced and separated packages 21. Once an outer packaging 22 is completely filled, it is removed by the conveyor belt 23 and replaced by a new outer packaging 22. Alternatively, the conveyor belt or conveying means 23 could also directly remove the separated packages 21, i.e. without outer packagings 22. As shown in FIG. 1, the conveying means 23 could be aligned transversely to the production direction R of the packaging machine 1 as well as in the production direction R or parallel to the production direction R.

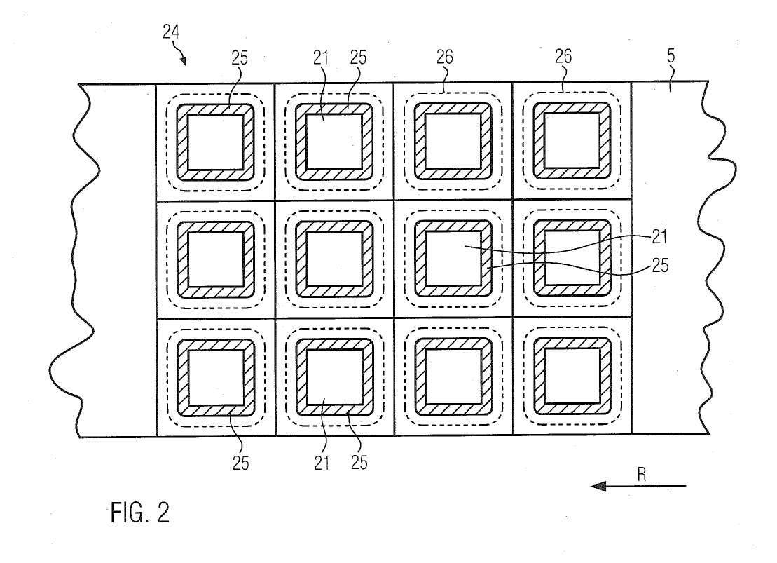

FIG. 2 shows a group 24 of twelve packages 21 simultaneously produced in one work cycle of the packaging machine 1. These twelve packages 21 are arranged in an array of three tracks and four rows. Each track extends in the production direction R of the coherent film 5, and each row extends transversely to the production direction R.

In the sealing station 3 each package 21 is provided with a sealed seam 25, which is located in the shape of a ring on the surrounding edge of the package 21. In the complete-cut station 4 the packages 21 are to be separated by cutting each package 21 out of the coherent film 5 along a cutting contour 26 which is supposed to be outside of the sealed seam 25. It would be optimal if the cutting contour 26 extended around the package 21 equidistantly with respect to the sealed seam 25, preferably with a smallest possible space from the sealed seam 25.

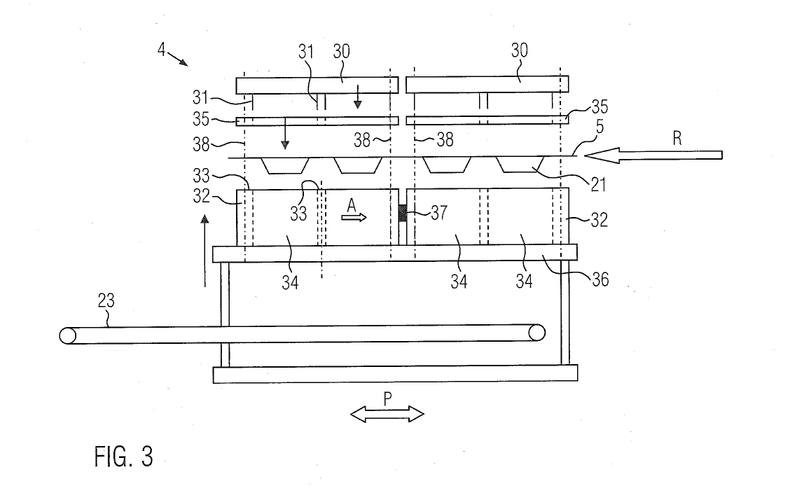

FIG. 3 shows in a schematic lateral view a first alternative of the complete-cut station 4 according to the invention. The complete-cut station has two separate cutting tools 30. Each of these cutting tools 30 comprises cutting knives 31 at their lower sides. The cutting knives 31 produce such a cutting contour 26 that two rows of packages 21 can be cut out of the coherent film 5 Consequently, the two cutting tools 30 are capable of cutting out four rows of packages 21 and, thus, the whole group 24 represented in FIG. 2 with 3×4 packages 21.

Two tray receptacles 32 are located underneath the cutting tools 30 and are each associated with one of the two cutting tools 30. Each tray receptacle 32 is provided to receive exactly the number of packages 21 that can be cut out by the associated cutting tool 30. The tray receptacles 32 have annular bearing surfaces 33 on which the edges of the packages 21 can rest during the separation. Drop shafts 34 are located between the bearing surfaces 33, through which the separated packages 21 can drop onto the conveying means 23 situated underneath the tray receptacles 32.

A clamping frame 35 capable of clamping the edges of a group 24 of packages 21 against the bearing surfaces 33 during the separation is provided between the cutting tools 30 and the associated tray receptacles 32. In the opened state of the complete-cut station 4 as shown in FIG. 3 the coherent film 5 with the packages 21 is conveyed between the clamping frames 35 and the bearing surfaces 33 into the complete-cut station 4 in production direction R.

A lifting gear 36 is provided as a common lifting drive for all cutting tools 30 and for all tray receptacles 32 of the complete-cut station 4. In the embodiment of FIG. 3 the lifting gear 36 is a lifting table which may be driven, for example, electromotively or pneumatically. Arrow P shows that the whole lifting table 36 carrying the cutting tools 30 and the tray receptacles 32 can be shifted in a direction along or opposite to the production direction R so as to allow an easy adjustment of the complete-cut station 4 to the position of the packages 21 or the desired position of the cutting line 26. This applies, in particular, to the position of the cutting tool 30 illustrated on the right and the associated tray receptacles 32 on the right, which are fixedly mounted on the lifting table 36 in a horizontal direction. They are aligned relative to one another to allow the cutting knives 31 of the cutting tool 30 to move into openings in the clamping frame 35 as well as into the drop shafts 34 of the tray receptacles 32.

The group of the cutting tool 30 and the associated tray receptacle 32 shown on the left is adjustable relative to the right cutting tool 30 in the horizontal direction, which is indicated by arrow A. During this horizontal adjustment of the position of the cutting tool the tray receptacle 32 always moves along, so that in this case, too, the cutting knives 31 are always capable of moving into the drop shafts 34 of the tray receptacle 32 if the cutting tool 30 is moved vertically to the tray receptacle 32. The horizontal adjustability of the cutting tool 30 shown on the left in direction A is limited by a stop 37 between the two tray receptacles 32. This stop 37 may be adjustable, e.g. in the form of a stop screw.

Vertical guides 38, e.g. guide rods, make sure that the cutting tools 30 and the clamping frames 35 are always aligned to the associated tray receptacles 32, even if the tray receptacles 32 and the cutting tools 30 move towards one another in a vertical direction.

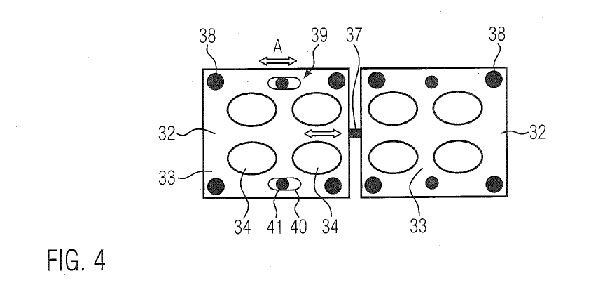

FIG. 4 shows a top view of the tray receptacles 32 of the complete-cut station 4 as illustrated in FIG. 3. Each tray receptacle 32 comprises four drop shafts 34 each having an oval contour. The drop shafts 34 are surrounded by a horizontal bearing surface 33. Each of the four corners of each tray receptacle 32 is penetrated by a vertical guide 38.

As described above, the right tray receptacle 32 is fixedly mounted on the lifting table 36, while the left tray receptacle 32 is adjustable with respect to its position in direction A, i.e. in the production direction R, together with the associated cutting tool 30 provided above the same. Two oblong hole guides 39 serve to guide and limit the horizontal adjustability of the tray receptacle 32 and the cutting tool 30. These oblong hole guides 39 are each comprised of an oblong hole 40, which is formed in the tray receptacle 32, and a bolt 41 penetrating through this oblong hole 40 and being fixedly mounted on the lifting table 36.

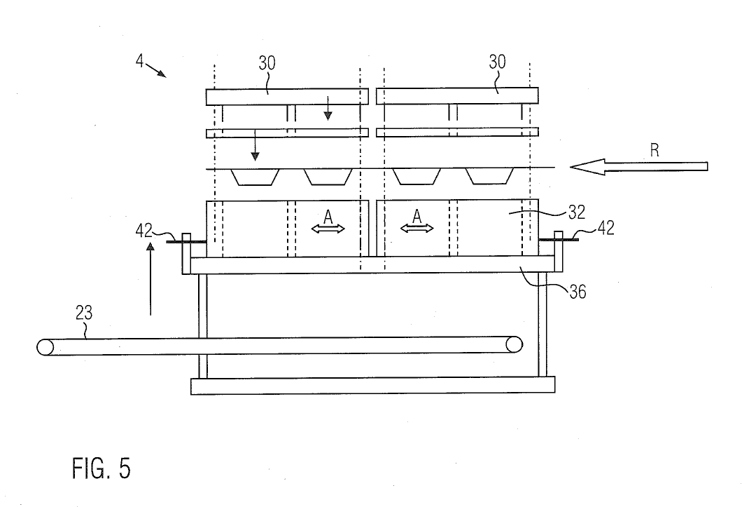

FIG. 5 shows a second embodiment of a complete-cut station 4. This embodiment merely differs from the embodiment shown in FIG. 3 by the two separate cutting tools 30 now being adjustable relative to one another and also relative to the lifting gear or lifting table 36, respectively, in the horizontal direction A. Horizontal guides 42 guide and limit the adjustability of the tray receptacles 32 and the associated cutting tools 30. In all embodiments it is conceivable that the cutting tools 30 can be adjusted not only in the production direction R, but, alternatively, or additionally, also transversely to the production direction R so as to allow an adjustment of the cutting contour 26 to the position of the sealed seams 25.

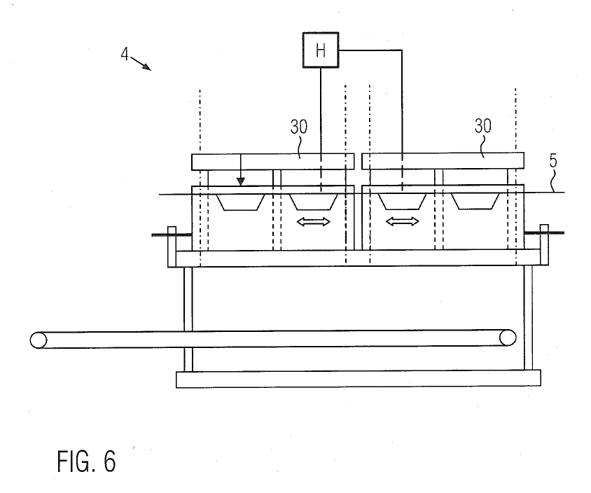

FIG. 6 shows the complete-cut station 4 illustrated in FIGS. 3 and 5 during the separation of the packages 21 from the coherent film 5 Proceeding from the opened states (FIGS. 3 and 5), initially the tray receptacles 32 and the clamping frames 35 were moved towards one another along the vertical guides 38 until the coherent film 5 is clamped between them. Subsequently, the cutting tools 30 move downwardly in the vertical direction along the guides 38 until the cutting knives 31 have cut through the coherent film 5 and, thus, separated the packages 21. A mechanism ensures that the lifting motion of the lifting gear 36 is transferred in a suitable fashion to the tray receptacles 32 for these working steps to be carried out. The lifting gear 36 thus serves as a common drive for all tray receptacles 32 of the complete-cut station 4. All cutting tools 30 and all clamping frames 35 may be driven by another common lifting drive H.

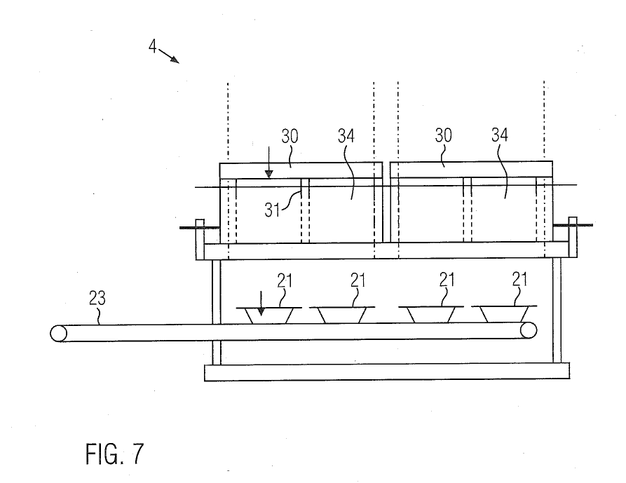

FIG. 7 shows the complete-cut station 4 at a time after the separation of the packages 21. The separated packages 21 have fallen through the drop shafts 34 and are now located on the conveying means 23, which can convey the packages 21 out of the complete-cut station 4 and thus out of the packaging machine 1.

In order to detect the position of the sealed seams 25 of the group 24 of packages 21 a measuring device 44 may be provided between the sealing station 3 and the complete-cut station 4, see FIG. 1. Such a measuring device 44 could be, for example, a camera having a suited image evaluation software, which detects the position of the sealed seams 25 and transmits it to the machine controller 18. The machine controller 18 can then adjust the position of the cutting tools 30 of the complete-cut station 4 so that the cutting contour 26 is optimally aligned relative to the position of the sealed seams 25.

Based on the described embodiment it is possible to modify the inventive complete-cut station and the inventive method in many ways. In particular, the complete-cut station 4 may be configured to separate any optional number of n×m packages 21. Moreover, the number of the cutting tools 30 of the complete-cut station is not limited to two, but there may also be provided three, four, five or more separately adjustable cutting tools 30.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A complete-cut station for separating a plurality of packages from a coherent film comprising:
a plurality of cutting tools, each cutting tool having cutting knives for separating a plurality of packages,
a plurality of tray receptacles wherein each cutting tool is associated with one of the plurality of tray receptacles,
at least one of the plurality of cutting tools being adjustable with respect to its position relative to at least one other of the plurality of cutting tools, and
a common lifting gear for the plurality of tray receptacles.

2. The complete-cut station of claim 1, wherein the at least one adjustable cutting tool is adjustable with respect to its position in a horizontal direction relative to the at least one other cutting tool.

3. The complete-cut station of claim 1, wherein the at least one adjustable cutting tool is adjustable with respect to its position in at least one of a direction parallel to a direction of production of the complete-cut station, and a direction transverse to the direction of production.

4. The complete-cut station of claim 1, wherein two or more of the plurality of cutting tools are adjustable relative to one another with respect to their positions.

5. The complete-cut station of claim 1 further comprising a guide member to limit the adjustability of the at least one adjustable cutting tool.

6. The complete-cut station of claim 5 wherein the guide member is a stop or an oblong hole guide.

7. The complete-cut station of claim 1 further comprising a conveyor for conveying the plurality of packages after separation, the conveyor being positioned underneath the plurality of cutting tools.

8. The complete-cut station of claim 1 further comprising a measuring device for detecting a position of one or more sealed seams on at least one of the plurality of packages.

9. A packaging machine comprising the complete-cut station of claim 1.

10. A method for separating packages from a coherent film comprising the following steps:
producing a plurality of sealed seams on a plurality of packages joined together by a coherent film,
correlating the position of at least one of the plurality of the sealed seams with the position of at least one of a plurality of cuts in the coherent film produced by one or more cutting tools of a complete-cut station,
adjusting the position of one or more cutting tools and one or more of a plurality of respectively associated tray receptacles of the complete-cut station relative to the position of at least one other of the plurality of cutting tools in dependence on the correlation between the position of the at least one of the plurality of the sealed seams and the position of the at least one of a plurality of cuts,
lifting of all the plurality of tray receptacles with a lifting gear to engage the plurality of the cutting tools to separate the plurality of packages from the coherent film with the plurality of cuts.

11. The method according to claim 10, further comprising detecting the position of at least one of the plurality of sealed seams on one or more of the plurality of packages and adjusting the position of one or more cutting tools in dependence on the detected position of the at least one detected sealed seam.

12. The method of claim 10, wherein the correlation between the position of the at least one of the plurality of the sealed seams and the position of the least one of the plurality of cuts producible by one or more cutting tools of the complete-cut station is realized by measuring a feed length of the coherent film.

13. The method of claim 10, wherein the adjusting step includes adjusting the position of one or more cutting tools and one or more of the plurality of respectively associated tray receptacles in a horizontal direction.

14. The method of claim 10 further comprising clamping the coherent film to one or more of the plurality of tray receptacles with a clamping frame prior to the separation of the plurality of packages.
